(19) United States
(12) Patent Application Publication
(10) Pub. No.: US 2008/0165406 A1
(43) Pub. Date: Jul. 10, 2008

(54) Subsurface Reticle

(76) Inventors: Ehud Galun, Rehovot (IL); Nisim Hadar, Hamovil (IL); Alon Tavory, Haifa (IL); Israel Vilenchik, Rehovot (IL); Ephraim Argaman, Petach Tikva (IL); Gidon Slosberg, Petach Tikva (IL); Moshe Toker, Rehovot (IL); Yosef Kigel, Rehovot (IL); Guy Ben-Zvi, Kibbutz Ramat Yohanan (IL); Rami Cohen, Hof Ashkelon (IL); Vladimir Dmitriev, Petersburg (RU); Sergey Oshemkov, Petersburg (IL)

Correspondence Address: Pearl Cohen Zedek Latzer, LLP, 1500 Broadway, 12th Floor, New York, NY, 10036, US

(21) Appl. No.: 11/885,785

(22) PCT Filed: Mar. 9, 2006
(86) PCT No.: PCT/IL06/00315

§ 371 Date: Sep. 6, 2007

Related U.S. Application Data
(60) Provisional application No. 60/659,041, filed on Mar. 7, 2005.

(51) Int. Cl. G02F 1/00; G02B 27/02

(52) U.S. Cl. 359/237; 359/436

(57) ABSTRACT

A reticle device is disclosed, comprising a transparent substrate provided with subsurface reticle design inscribed within the substrate.

### FIELD OF THE INVENTION

The present invention relates to reticles. More particularly it relates to a subsurface reticle within a transparent medium.

### BACKGROUND OF THE INVENTION

Reticles are used in optical systems in order to superimpose a certain image on the viewed scene. A reticle typically comprises a network of fine lines, dots, cross-hairs or other similar such designs, positioned in the focal plane of the eyepiece of an optical instrument, for the purpose of aiding aiming the optical instrument, aligning it, or pointing it in a desired direction.

The reticle must be placed at the focal plane of the eyepiece where a true image of the scene is formed in order to be seen clearly. The graphics on the reticle blend with this true image and the observer sees it as part of the scene. However, this is true for any irregularity of the area in the focal plane that is magnified by the eyepiece and degrades the quality of the scene image. Also, the surface area in the focal plane is reflecting some of the energy in an uncontrolled way, thereby creating stray light in the system that degrades the optical quality of the image. Reticles are used in the vision, detection and pointing industry to align a scene feature with the device line of sight, sometimes with a predetermined offset.

Commonly a reticle is inscribed on a surface of a transparent medium (for example, a glass substrate or silicon substrate). The reticle is thus prone to physical wear and may, in time, be damaged or totally disappear. To tackle this problem a protective layer is usually used in the form of an additional panel cemented onto the substrate. However this solution brings about reflection problems associated with the additional surfaces. Moreover, as any regularities and defects in the reticle plane are distinctly and highly observable, the protective layer may increase the risk of visible defects.

It is a purpose of the present invention to provide a novel reticle inscribed within the glass plate (or other transparent medium), thus eliminating the risk of physical wear of the reticle.

### SUMMARY OF THE INVENTION

There is thus provided, in accordance with -some preferred embodiments of the present invention, a reticle device comprising a transparent substrate provided with subsurface reticle design inscribed within the substrate.

Furthermore, in accordance with some preferred embodiments of the present invention, the device is incorporated in an instrument selected from a group of instruments including: vision, detection and pointing instruments.

Furthermore, in accordance with some preferred embodiments of the present invention, the instrument is selected from a group of instruments including: medical instruments, measurement instruments, engineering instruments, military devices, navigation aids, vehicular instruments.

Furthermore, in accordance with some preferred embodiments of the present invention, the size of the reticle design varies in the range between 3 to 100 mm.

Furthermore, in accordance with some preferred embodiments of the present invention, the reticle design comprises a line design, the line width being in the range between 5 to 500 millimicrons.

Furthermore, in accordance with some preferred embodiments of the present invention, the reticle design is inscribed below the surface of the substrate in a zone up to 5 mm deep.

Furthermore, in accordance with some preferred embodiments of the present invention, the substrate comprises a transparent dielectric.

Furthermore, in accordance with some preferred embodiments of the present invention, the substrate comprises a semiconductor.

Furthermore, in accordance with some preferred embodiments of the present invention, there is provided a method of inscribing a subsurface reticle design within a transparent substrate, the method comprising:

providing an optical system comprising a primary light beam source; a beam splitter; a light modulation array, and a focusing lens array;

placing the substrate in front of the optical system;

generating using the light source a primary light beam of a predetermined polarization;

splitting the primary light beam into a plurality of secondary light beams, arranged in a two-dimensional array;

separately modulating each secondary beam;

focusing the secondary beams onto a predetermined target within the substrate so as to inscribe a reticle design of a predetermined pattern.

Furthermore, in accordance with some preferred embodiments of the present invention, the light source is a laser source.

Furthermore, in accordance with some preferred embodiments of the present invention, the laser source is selected from a group of laser sources including: ruby laser source, Nd:YAG laser source, Q-switched pulsed Nd:YAG pulsed laser source, continuous wave laser source.

Furthermore, in accordance with some preferred embodiments of the present invention, the beam splitter comprises a beam splitter selected from a group including: diffractive beam splitters, birefringence beam splitters.

Furthermore, in accordance with some preferred embodiments of the present invention, the optical system further comprises an angular beam scanner.

Furthermore, in accordance with some preferred embodiments of the present invention, the method further comprises placing the substrate on an X-Y stage and moving it during the inscribing of the reticle design.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1a is an isometric view of a substrate with a subsurface reticle in accordance with a preferred embodiment of the present invention.

FIG. 1b is a side view of the substrate with a subsurface reticle shown in FIG. 1a.

FIG. 2 illustrates a proposed optical system for inscribing subsurface reticle within a transparent substrate.

### DETAILED DESCRIPTION OF PREFERRED EMBODIMENTS

A main aspect of the present invention is the provision of a reticle within a transparent substrate, rather than on an outer surface of the substrate. By the term “transparent” it is meant, in the context of the present invention any material that allows electromagnetic radiation in any frequency or spectral band to at least partially pass through.

Another aspect of the present invention is the use of pulsed light source to cater for high-resolution and precise design for the reticle.

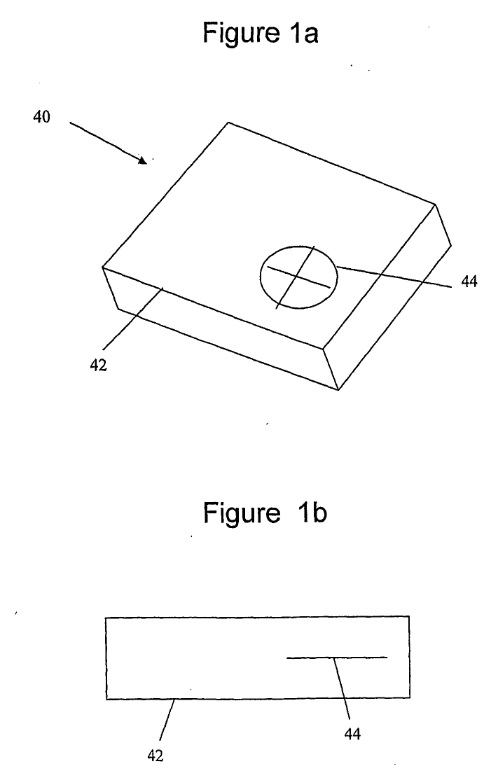

Reference is made to FIG. 1a illustrating an isometric view of a substrate with a subsurface reticle, generally denoted by numeral 10, in accordance with a preferred embodiment of the present invention. The substrate 12 is a transparent medium through which an electromagnetic radiation of a given frequency or spectral band can traverse. Reticle 14 is inscribed within the substrate at a predetermined location beneath the surface of the substrate. The reticle itself can be designed to meet any optical or graphical requirement. The width of the inscribed line depends on the desired design and the resolution of the optical apparatus used for inscribing the reticle within the substrate. Typically, for reticles used in vision, detection and pointing instruments. These may include medical instruments, measurement instruments, engineering instruments, military devices, navigation aids, vehicular instruments. The size of the reticle design varies in the range between 3 to 100 mm. The line width may vary, for the same purposes, between 5 to 500 millimicrons.

FIG. 1b is a side view of the substrate with a subsurface reticle shown in FIG. 1a. The reticle design may be inscribed at any desired target location within the substrate. Typically (for vision, detection and pointing reticles) the reticle will be inscribed below the surface of the substrate ranging from a few millimicrons to 5 mm.

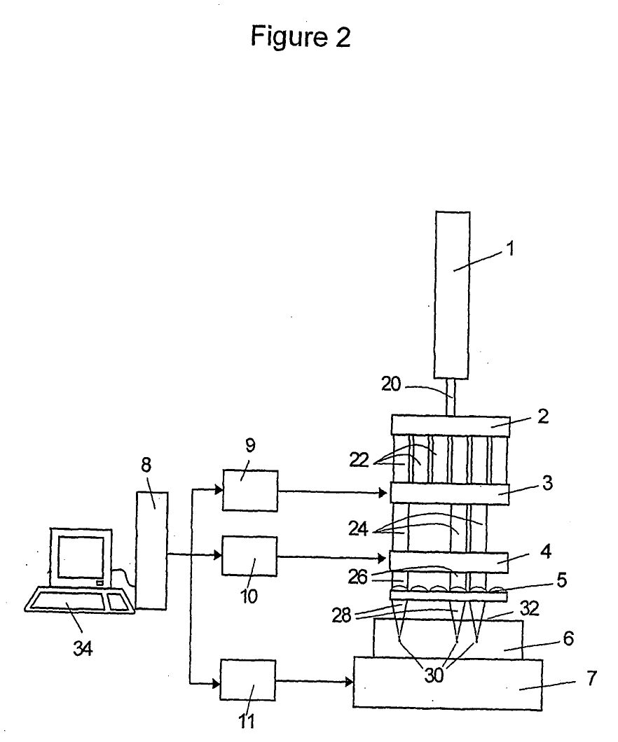

Reference is now made to FIG. 2, illustrating a schematic view of an apparatus for laser machining with individually controllable multiple beams, that may be used in inscribing the reticle design within a transparent substrate, in accordance with the present invention.

The apparatus generally comprises a primary light beam source, beam splitter, light modulator array and focusing lens array.

The Primary light beam source generates a primary light beam 20, having a predetermined polarization (plane polarized light beam), and can be any laser beam source, for example ruby laser, Nd:YAG laser, or any other laser, pulsed or continuous wave (CW) laser. For the purpose of machining by performing optical breakdown it is recommended to employ a Q-switched pulsed Nd:YAG laser (may be obtained from, for example, Lee Laser, Inc., of Orlando Fla., USA, or from Kigre, Inc., of Hilton Head, S.C., USA), with typical pulse duration of up to 10⁻⁸-10⁻⁷ seconds , and pulse energy of up to 100 mJ or mode-locked picosecond lasers with pulse energy about 1 mJ from Time Bandwidth of Zurich, Switzerland, or femtosecond amplified systems with pulse energy about 1 mJ from Clark MXR, Dexter, Mich., USA. A beam splitter 2 is provided in front of the primary light beam source 1, for the purpose of splitting the primary light beam 20 into a predetermined plurality of secondary beams 22, arranged in a two dimensional array.

The beam splitter may be any type of beam splitters, such as a diffractive beam splitter, birefringence beam splitter or the like.

It is noted here that any other type of light modulator array can replace the LC array of the embodiment of FIG. 1, as long as it performs similarly. In other words, any array of separately controllable elements, that may each be switched from transparent to opaque with reference to the light irradiated on the array (i.e. letting light through in the transparent mode and blocking the light in the opaque mode) may be suited for the job, and hence is covered by the scope of the present invention. By “opaque” it is meant in, the context of the present invention, any deterioration in the intensity of light passing through the light modulator array so that it gets below the intensity required for the light to perform the task it is designed for (for example, cause optical breakdown or cut through the material of the workpiece). For example, typical damage threshold for fused silica are about 200 J/cm² for 10 ns, 10 J/cm² for 30 ps and 3 J/cm² for 100 fs pulses (An-Chun Tien et al Phys. Rev. Letters, v. 82, pp. 3883-3886, 1999).

Optionally an angular beam scanner 4 is provided, positioned to intercept the light beams 24 escaping from the light modulator array 3. The angular beam scanner may be, for example, galvanometer scanner, piezo-optical scanner, or acousto-optical scanner. The angle beam scanner can deflect the light beams that reach it, so as to widen the work area of the beams and enhance the flexibility of the apparatus increasing the span and coverage of the light beams. Angular beam scanner 4 is controlled by angle beam control unit 10, which activates the angle beam scanner to deflect the light beams in the desired direction. It is emphasized that the angle beam scanner is an optional feature that may be omitted in other embodiments of the present invention.

Finally a focus lens array 5 is positioned in a predetermined position, aligned with the rest of the optics, so as to focus each of (or at least some of) the beams 26 emerging from the angle beam scanner 4, having a predetermined focus 30 so as to facilitate the processing of the workpiece 6. Generally this means that the focus would be designed to overlap the surface 32 of the workpiece, facing the optics of the apparatus, or facilitate penetration of the focused light beams 28 into the workpiece 6. The microlens array may be an array of refractive or diffractive lenses.

A moving, motor-driven, XYZ stage 7, which can be maneuvered to reposition in space with respect to the optics of the apparatus is provided, generally positioned in front of the optics of the apparatus. The stage may be moved in one, two or three dimensions (preferably in three dimensions, so as to allow spatial accessibility for the light beams, and also speed up the process of machining of the workpiece, as the workpiece is quickly moved to a desired position and there those light beams that are focused on the workpiece may perform their task. Generally the moving stage would be actuated to reposition the workpiece between a single, or a sequence, of actuation of the secondary beams. The reposition of the workpiece is aimed at accessing different parts of the workpiece in cases where the overall job is larger than the span of the entire secondary beam bundle. Resolution of this stage should be typically about 0.1-1.0 μm, repeatability about 0.1-1.0 μm and travel distance about 10 cm. Such stage may be obtained, for example, from PI, Newport and other companies.

The workpiece (substrate), which the apparatus of the present invention is designed to process, may be a transparent dielectric, semiconductor or any other item that is suited for machining using the apparatus of the present invention.

Control unit 8 is preferably a computerized controller that is adapted to activate and coordinate the operation of light modulator array 3, angular beam scanner 4 and moving stage 7 and laser source 1.

Control unit 8 may be governed by software, setting the desired commands and order of operation of the controlled elements of the apparatus, so as to perform a predetermined task such as forming an image inside a transparent workpiece, or machining a silicon wafer to form a semiconductor of a predetermined shape.

Optional user interface 34, such as a keyboard, touch screen or the like, is provided for inputting commands to the control unit 8.

In a preferred embodiment of the apparatus of the present invention, the energy efficiency and productivity are greatly increased with respect to prior art apparatus. If, for example, 1 kHz repetition rate ultrafast laser is used in combination with computer-controlled 30×30 matrix spatial light modulator and fast angle beam scanner, it allows to produce up to the order of 10⁶ damage spots per second.

It is important to note that while in the embodiment of FIG. 1 the secondary light beams are arranged in a parallel configuration, a person skilled in the art may design an embodiment of the present invention manipulating non-parallel secondary beams—be it the beams that leave the beam splitter, the light modulator array or the angular beam scanner—that would still be covered by the scope of the present invention.

Generally the apparatus of the present invention provides a fast responsive and yet more accurate means for optical machining, which is superior to multiple beam apparatus, whose beams are controlled mechanically (such as described in U.S. Pat. No. 6,037,564, or U.S. Pat. No. 4,950,862 that describes a single beam mechanical manipulation).

Furthermore, separate control over each of the beams is achieved, allowing assigning each beam a separate task, as opposed to the parallel performance of the light beams in the apparatus shown in U.S. Pat. No. 5,521,628, thus combining the overall performance of the apparatus to accomplish sophisticated and complex tasks, such as assigning each beam a part of a complete image that is to be imprinted in a glass block, or assign each beam a part of the shape that is to be engraved (or cut, or drilled, or ablated) on a silicon workpiece, or any other machining task on any type of workpiece.

It is noted that although in the embodiment of FIG. 2 there are three separate control units (9, 10, 11 and 8) for controlling the light modulator array 3, the angular beam scanner 4, the moving stage 7, and a main controller governing these control unit, a person skilled in the art may easily design a single multi-tasking controller to replace these control units, and that would be also covered by the scope of the invention.

It is estimated that the time required to accomplish a complex machining task, by an apparatus according to the present invention, would be significantly shortened, with respect to the time it would take any of the prior art optical machining apparatus to complete the same task.

The optical inscribing apparatus shown in FIG. 2 is merely an example. The design of the apparatus shown in this Figure is aimed at providing parallel writing ability, thus substantially increasing the speed of writing. However employing point-by-point inscribing techniques is also applicable.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A reticle device comprising a transparent substrate provided with subsurface reticle design inscribed within the substrate.

2. The device of claim 1, incorporated in an instrument selected from a group of instruments consisting of: vision, detection and pointing instruments.

3. The device of claim 2, wherein the instrument is selected from a group of instruments consisting of: medical instruments, measurement instruments, engineering instruments, military devices, navigation aids, and vehicular instruments.

4. The device of claim 1, wherein the size of the reticle design varies in the range between 3 to 100 mm.

5. The device of claim 1, wherein the reticle design comprises a line design, the line width being in the range between 5 to 500 millimicrons.

6. The device of claim 1, wherein the reticle design is inscribed below the surface of the substrate in a zone up to 5 mm deep.

7. The device of claim 1, wherein the substrate comprises a transparent dielectric.

8. The device of claim 1, wherein the substrate comprises a semiconductor.

9. A method of inscribing a subsurface reticle design within a transparent substrate, the method comprising:
providing an optical system comprising a primary light beam source, a beam splitter, a light modulation array, and a focusing lens array;
placing the substrate in front of the optical system;
generating using the light source a primary light beam of a predetermined polarization;
splitting the primary light beam into a plurality of secondary light beams, arranged in a two-dimensional array;
separately modulating each secondary beam; and
focusing the secondary beams onto a predetermined target within the substrate so as to inscribe a reticle design of a predetermined pattern.

10. The method of claim 9, wherein the light source is a laser source.

11. The method of claim 10, wherein the laser source is selected from a group of laser sources consisting of: ruby laser source, Nd:YAG laser source, Q-switched pulsed Nd:YAG pulsed laser source, and continuous wave laser source.

12. The method of claim 9, wherein the beam splitter comprises a beam splitter selected from a group consisting of: diffractive beam splitters, and birefringence beam splitters.

13. The method of claim 9, wherein the optical system further comprises an angular beam scanner.

14. The method of claim 9, further comprising placing the substrate on an X-Y stage and moving it during the inscribing of the reticle design.
